(19) United States
(12) Patent Application Publication
(10) Pub. No.: US 2005/0186860 A1
(43) Pub. Date: Aug. 25, 2005

(54) Throttle valve control motor with an electrical plug connnection system

(76) Inventors: Christian Lorenz, Aalen-Unterrombach (DE); Bernd Rometsch, Gerlingen (DE); Roland Zoelch, Barnau (DE)

Correspondence Address: RONALD E. GREIGG;GREIGG & GREIGG P.L.L.C., Suite One, 1423 Powhatan Street, Alexandria, VA, 22314, US

(21) Appl. No.: 11/045,333

(22) Filed: Jan. 31, 2005

(30) Foreign Application Priority Data
Jan. 29, 2004 (DE) 10 2004 004 410.4

(51) Int. Cl. H01R 13/187

(52) U.S. Cl. 439/857

(57) ABSTRACT

An electrical plug connection system for a throttle valve control motor for a motor vehicle includes in a female plug component having a contact lug on its end region with a convex or flattened surface portion which the comes to rest on a contact pin of a male plug component. Moreover, between its end regions, the contact lug has a stamped indentation that reduces the cross-sectional area of the contact lug and lengthens the contact lug in the direction of the contact pin.

### BACKGROUND OF THE INVENTION

1. Field of the Invention

The invention relates to a throttle valve control motor having an electrical plug connection system, and in particular to a female plug component, provided there, for connection to at least one contact pin of a male plug component, having at least one contact lug, which is retained by a first end region on a carrier of the female plug component and is meant to rest with its opposite, second end region on the contact pin of the male plug component.

2. Description of the Prior Art

Electrical plug connection systems of the type described above used, for instance, in a motor vehicle, serve to provide electrical contact of a cable harness plug with a carrier substrate of the throttle valve control motor; in that case, an electric motor and/or a potentiometer must be connected to the cable harness of the motor vehicle at the carrier substrate. The potentiometer is coupled for instance to a throttle valve shaft of the electric motor and ascertains the actual throttle valve position. With the aid of an electronic closed-loop control unit, the electric motor can be triggered accordingly and the throttle valve position can be corrected if needed. The electrical components of this closed-loop control circuit are connected to one another via electrical cables, which requires many contacting points on the cable harness plug, on the electric motor, and on the potentiometer. Along with rigid connections made for instance by welding or soldering, such contacting points comprise connections made by crimping, or plug connections.

Plug connections have the advantage that they can easily be joined together if needed. However, particularly with plug connections, there is an increased risk that the contacts to be made between the male and the female plug component are not durable over the service life of the electrical plug connection system. Moreover, the contact pins and contact lugs to be made on the male and female plug components can be produced only with dimensional tolerances, and the electrical plug connection system must necessarily cover the entire possible range of tolerances in principle.

### OBJECT AND SUMMARY OF THE INVENTION

It is the object of the invention to improve an electrical plug connection system of the type described above in such a way that an electrical connection between a female and a male plug component is made in an economical way and can cover a wide range of tolerances with respect to the dimensional accuracy of the plug pin and contact lug and at the same time assures secure contacting over the service life of the electrical plug connection system.

According to the invention, this object is attained with a female plug component in which the at least one contact lug, on its second end region, is provided with a convex or flattened surface portion with which the contact lug comes to rest on the contact pin of the male plug component. The object is also attained with a corresponding female plug component in which the at least one contact lug is provided with a stamped indentation between its first and second end regions, and in particular is lengthened or extended by means of such a stamped feature from the first end region in the direction of the contact pin of the male plug component.

In combination with a female plug component of this kind with an associated male plug component, an electrical plug connection can advantageously be made, in particular between a cable harness plug of a throttle valve control motor and an associated carrier substrate. In particular, the plug connection withstands the adverse, widely fluctuating factors that exist in the surroundings of a motor vehicle engine compartment.

The contact lug of the invention does not rest on the associated contact pin with one edge but instead with a convex or a flattened surface portion. The contact area between the contact pin and the contact lug is therefore comparatively large, and a possible increase in the transfer resistance between these components has a comparatively slight effect over the service life of the electrical plug connection of the invention.

The electrical plug connection system of the invention covers a wide range of tolerances in terms of possible dimensional deviations of the plug components involved, because the at least one especially adapted contact lug of the female plug component has great elasticity, because of the stamped indentation provided. With the elongation or extending of the at least one contact lug in the direction toward the contact pin as provided according to the invention, the possible range of tolerances in the three-dimensional arrangement of the contact pin and contact lug can be allowed to be comparatively wide.

The stamped indentation provided according to the invention for reducing the cross-sectional area of the contact lug is especially advantageously designed as extending transversely to the insertion direction of the contact pin of the male plug component and in particular on the back side of the at least one contact lug. The stamped indentation of this kind reduces the bending strength and increases the elasticity of the contact lug upon bending in the insertion direction.

To make bending the contact lug even easier, the contact lug is advantageously pre-bent in the insertion direction of the contact pin of the male plug component. Because of the pre-bending, an insertion bevel is formed, and the contact pin can be pushed in especially easily along it.

### BRIEF DESCRIPTION OF THE DRAWINGS

The invention will be better understood and further objects and advantages thereof will become more apparent from the ensuing detailed description of a preferred embodiment, taken in conjunction with the drawings, in which:

FIG. 1 is a longitudinal section through an exemplary embodiment of a female plug component according to the invention; and

FIG. 2 shows the longitudinal section of FIG. 1, with a male plug component disposed on the female plug component.

### DESCRIPTION OF THE PREFERRED EMBODIMENT

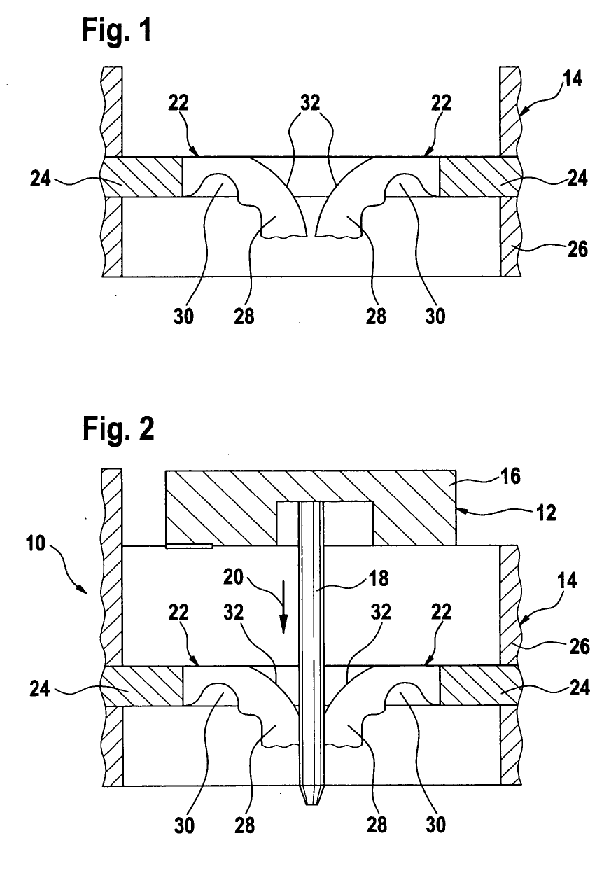

In FIGS. 1 and 2, an electrical plug connection system 10 is shown, which includes a cable harness plug or contact pin mount 12, as the male plug component, and a carrier substrate 14 as the female plug component. The cable harness plug 12 serves the purpose of electrically contacting the carrier substrate 14, which in turn serves as a mount for an electric motor, not shown, and a potentiometer, also not shown.

The cable harness plug 12 is designed with a substantially cylindrical plug body 16, from which a plurality of contact pins protrude substantially at a right angle on an end face, and of these one contact pin 18 is shown.

The contact pin 18 is pushed in an insertion direction 20 in between two contact lugs 22, which are each retained by a first end region 24 on the carrier substrate 14. The contact lugs 22 extend substantially transversely to the insertion direction 20 in the carrier substrate 14 and are thus located in a plane that is substantially perpendicular to this insertion direction 20. The first end region 24 of each of the contact lugs 22 is potted in a carrier 26 of the carrier substrate 14.

The second end region 28, remote from the respective first end region 24, of each of the substantially elongated contact lugs 22 rests on the contact pin 18 and thus forms an electrical connection between the contact pin 18 and the contact lug 22.

To assure this electrical contact between the two components 18 and 22 over the service life of the electrical plug connection system 10, this second end region 28 of the respective contact lugs 22 is produced by means of a stamping operation, in which, particularly on the side of the respective contact lug 22 remote from the contact pin 18, one stamped indentation 30 is made in the material of the contact lugs 22, between the first end region 24 and the second end region 28 of each.

With the respective stamped indentation 30, the associated cross-sectional area of the respective contact lug 22 is reduced, such that the bending strength of the contact lug 22 is less and its elasticity is greater than in a contact lug without a stamped indentation. Moreover, the stamped indentations 30 bring about a lengthening or extension of the respective associated contact lugs 22 in the direction toward the contact pin 18.

Pre-bending the contact lugs 22 in the insertion direction 20, which is also done in the embossing operation, forms a kind of insertion funnel, with which the contact pin 18 is introduced and guided between the two contact lugs 22.

The lengthened or extended and pre-bent contact lugs 22 furthermore make a wider range of tolerances possible, in the event of possible dimensional deviations between the cable harness plug 12 and the carrier substrate 14.

By means of the aforementioned embossing operation, moreover, one convex surface portion 32 each, oriented toward the contact pin 18, has been embodied on the contact lugs 22, which upon insertion of the contact pin 18 comes to rest on it. With the convex surface portion 32, a durably good contact is created between the contact pin and the contact lugs 22, yet nevertheless the contact pin 18 can be released again comparatively easily from the plug connection thus made.

The foregoing relates to a preferred exemplary embodiment of the invention, it being understood that other variants and embodiments thereof are possible within the spirit and scope of the invention, the latter being defined by the appended claims.

1. In a female plug component (14) for connection to at least one contact pin (18) of a male plug component (12), having at least one contact lug (22), which is retained by a first end region (24) on a carrier (26) of the female plug component (14) and is meant to rest with an opposite, second end region (28) on the contact pin (18) of the male plug component (12), the improvement wherein the at least one contact lug (22), has a convex surface portion (32), on its second end regions (28) with which contact surface portion (32) the contact lug (22) comes to rest on the contact pin (18) of the male plug component (12).

2. In a female plug component (14) for connection to at least one contact pin (18) of a male plug component (12), having at least one contact lug (22), which is retained by a first end region (24) on a carrier (26) of the female plug component (14) and is meant to rest with an opposite, second end region (28) on the contact pin (18) of the male plug component (12), the improvement wherein the at least one contact lug (22), has a flattened surface portion on its second end regions (28), with which flattened surface portion the contact lug (22) comes to rest two-dimensionally on the contact pin (18) of the male plug component (12).

3. A female plug component (14) according to claim 1, wherein the at least one contact lug (22), between its first and second end regions (24 and 28), is provided with a stamped indentation (30) that reduces the cross-sectional area of the contact lug (22).

4. A female plug component (14) according to claim 2, wherein the at least one contact lug (22), between its first and second end regions (24 and 28), is provided with a stamped indentation (30) that reduces the cross-sectional area of the contact lug (22).

5. The female plug component in accordance with claim 3, the stamped indentation (30) that reduces the cross-sectional area of the contact lug (22) extends transversely to the insertion direction (20) of the contact pin (18) of the male plug component (12).

6. The female plug component in accordance with claim 4, the stamped indentation (30) that reduces the cross-sectional area of the contact lug (22) extends transversely to the insertion direction (20) of the contact pin (18) of the male plug component (12).

7. The female plug component in accordance with claim 3, wherein the stamped indentation (30) that reduces the cross-sectional area of the contact lug (22) is embodied on the back side of the at least one contact lug (22), relative to the insertion direction (20) of the contact pin (18) of the male plug component (12).

8. The female plug component in accordance with claim 4, wherein the stamped indentation (30) that reduces the cross-sectional area of the contact lug (22) is embodied on the back side of the at least one contact lug (22), relative to the insertion direction (20) of the contact pin (18) of the male plug component (12).

9. The female plug component in accordance with claim 5, wherein the stamped indentation (30) that reduces the cross-sectional area of the contact lug (22) is embodied on the back side of the at least one contact lug (22), relative to the insertion direction (20) of the contact pin (18) of the male plug component (12).

10. The female plug component in accordance with claim 6, wherein the stamped indentation (30) that reduces the cross-sectional area of the contact lug (22) is embodied on the back side of the at least one contact lug (22), relative to the insertion direction (20) of the contact pin (18) of the male plug component (12).

11. A female plug component (14) in accordance with claim 1, wherein the at least one contact lug (22) is lengthened by a stamped indentation (30) that reduces the cross-sectional area of the contact lug (22), the indentation (30) beginning at the first end region (24) and extending in the direction of the contact pin (18) of the male plug component (12).

12. A female plug component (14) in accordance with claim 2, wherein the at least one contact lug (22) is lengthened by a stamped indentation (30) that reduces the cross-sectional area of the contact lug (22), the indentation (30) beginning at the first end region (24) and extending in the direction of the contact pin (18) of the male plug component (12).

13. The female plug component in accordance with claim 11, wherein the at least one contact lug is pre-bent in the insertion direction (20) of the contact pin (18) of the male plug component (12).

14. The female plug component in accordance with claim 12, wherein the at least one contact lug is pre-bent in the insertion direction (20) of the contact pin (18) of the male plug component (12).

15. An electrical plug connection system (10) having a male plug component (12) and a female plug component (14) in accordance with claim 1.

16. An electrical plug connection system (10) having a male plug component (12) and a female plug component (14) in accordance with claim 2.

17. An electrical plug connection system (10) having a male plug component (12) and a female plug component (14) in accordance with claim 3.

18. An electrical plug connection system (10) having a male plug component (12) and a female plug component (14) in accordance with claim 5.

19. A throttle valve control motor for a motor vehicle, having an electrical plug connection system (10) in accordance with claim 15, wherein the male plug component is a cable harness plug (12), and the female plug component is a carrier substrate (14) that retains an electric motor and/or a potentiometer.

20. A throttle valve control motor for a motor vehicle, having an electrical plug connection system (10) in accordance with claim 16, wherein the male plug component is a cable harness plug (12), and the female plug component is a carrier substrate (14) that retains an electric motor and/or a potentiometer.
